(19) United States
(12) Patent Application Publication
(10) Pub. No.: US 2010/0098925 A1
(43) Pub. Date: Apr. 22, 2010

(54) Multi-layer nanocomposite materials and methods for forming the same

(76) Inventors: Paula D. Fasulo, Eastpointe, MI (US); William R. Rodgers, Bloomfield Township, MI (US); Robert A. Ottaviani, Anthem, AZ (US)

Correspondence Address: Julia Church Dierker;Dierker & Associates, P.C., 3331 W. Big Beaver Road, Suite 109, Troy, MI, 48084-2813, US

(21) Appl. No.: 11/544,955

(22) Filed: Oct. 6, 2006

Related U.S. Application Data
(60) Provisional application No. 60/724,665, filed on Oct. 7, 2005.

(51) Int. Cl. B32B 27/32; B32B 27/28; B32B 27/40; B32B 27/34; B29C 47/04

(52) U.S. Cl. 428/220; 428/515; 428/412; 428/423.1; 428/474.4; 428/454; 428/446; 428/339; 156/244.24; 264/113

(57) ABSTRACT

A multi-layer nanocomposite material includes a first layer of a first polymeric material and a second layer of nanocomposite material. The nanocomposite material includes a second polymeric material and a nanofiller material exfoliated therewithin. The second layer is established on the first layer, or the first layer is established on the second layer. The multi-layer nanocomposite material exhibits enhanced physical properties and enhanced ductility due to the improved stress dissipation of the secondary layers during impact.

### CROSS REFERENCE TO RELATED APPLICATIONS

This application claims the benefit of U.S. Provisional Patent Application Ser. No. 60/724,665 filed on Oct. 7, 2005.

### TECHNICAL FIELD

The present disclosure relates generally to nanocomposite materials, and more particularly to multi-layer nanocomposite materials and methods for forming the same.

### BACKGROUND

Nanotechnology can be defined as materials or devices engineered at the molecular level. Within this category are polymer nanocomposites, which are a class of materials that use molecular sized particles for reinforcing the polymer matrix, e.g., the reinforcing filler possesses one or more dimensions on a sub-micrometer scale. These materials blend a nanofiller with a polymer to produce a composite with equal or better physical and mechanical properties than their conventionally filled counterparts, but at lower filler loadings.

Due to the surface area available with nanofillers, polymer nanocomposites offer the potential for enhanced mechanical properties, barrier properties, thermal properties, and the like when compared to conventionally filled materials.

One class of polymer nanocomposites uses a nanofiller material that is based on the smectite class of aluminum silicate clays, a common representative of which is montmorillonite. Although naturally occurring and synthetic variations of this basic mineral structure can be used to make nanocomposites, the structure should allow the exchange of interlayer inorganic cations, such as Na⁺ or Ca²⁺, with organic cations, such as alkylammonium cations, if property enhancements are to be achieved. The silicate platelets consist of a central octahedral aluminate structure surrounded on either side with a tetrahedral silicate structure. Iron or magnesium occasionally replaces an aluminum atom, rendering an overall negative charge. This charge is counterbalanced by the inorganic cations which reside between the sheets, holding them loosely together. The exchange of interlayer inorganic cations with organic cations increases the spacing between the silicate sheets, as well as improves the compatibility of the filler and the resin system, thereby facilitating exfoliation.

When exfoliated properly, these layered silicates have size dimensions approximately 1 nm thick by about 50 to 2000 nm long. This leads to aspect ratios on the order of about 50 to 2000. This value is quite high compared to the aspect ratio of conventional fillers such as talc (aspect ratio˜1) and glass fibers (aspect ratio˜20). Due, at least in part, to this high aspect ratio and the surface area generated by this sub-micron reinforcing filler, there is the potential to obtain properties equal to or greater than conventionally filled materials but at much lower filler loadings, for example, between about 2% and about 5%. Conventionally filled materials require about 20% to 30% loadings to achieve equivalent property enhancement.

For optimum reinforcement properties, not only is good exfoliation desirable, but also good distribution of the silicate layers throughout the resin, and good compatibility between the polymer resin and the filler.

Polymer layered-silicate (PLS) nanocomposites are materials composed of organoclay platelets dispersed throughout a polymer matrix. Nanocomposite materials have shown enhanced mechanical and thermal properties when compared to their base homopolymers. Increased modulus and reduced linear thermal expansion are characteristics that make polymer nanocomposites desirable materials for many industries, including but not limited to the automotive industry.

The attractive characteristics of PLS nanocomposites are brought about through the intercalation and exfoliation of the clay platelet stacks. Successfully exfoliated nanocomposite materials have been created through directly polymerizing the polymer matrix between the platelet stacks. Such methods have led to high degrees of exfoliation and subsequently high aspect ratios A_{f}, the ratio of the large lateral dimension of the clay to its nanoscale thickness. Theoretical models have related the aspect ratios of aligned platelets to the tensile moduli of the nanocomposite. As shown by FIG. 4, the modulus initially depends strongly on the aspect ratio, then reaches a plateau at higher values of A_{f}. For ˜2 vol % clay, an aspect ratio of 100 appears to be an optimal target for achieving an appreciable tensile modulus improvement. In FIG. 4, subscripts c and m indicate composite and polymer matrix, respectively. The points are data reported for organoclay (OC): 1.5 vol % in PA-6, in-situ polymerized (solid square), 1 vol % in PA-6, melt blended (open square), and 0.75 vol % in PP, melt blended (circle). Currently, melt-blending techniques have not exceeded an aspect ratio of about 75. The results so far with polypropylene are even less desirable. The highest aspect ratio reported so far, A_{f}=38, has been achieved using a twin-screw extruder and 100% maleic anhydride grafted polypropylene (PP-g-MA).

Polymeric nanocomposites (one example of which includes polypropylenes) may be particularly attractive due to the relatively low cost, relatively low density, relatively high thermal stability, and desirable solvent resistance of the polymer. However, polymeric nanocomposite formation may be challenging due, at least in part, to the lack of affinity between the organophilic polymeric material and the hydrophilic clay. Further, as reinforcement of polymeric materials increases, the ductility of the reinforced polymeric material generally decreases.

As such, it would be desirable to provide polymeric nanocomposite materials having nanofiller material dispersed and/or exfoliated therewithin. It would further be desirable to provide such a polymeric nanocomposite material having enhanced ductility.

### SUMMARY

The present disclosure provides a multi-layer nanocomposite material including a first layer of a first polymeric material and a second layer of nanocomposite material. The nanocomposite material includes a second polymeric material and a nanofiller material substantially exfoliated therewithin The second layer is established on the first layer, or the first layer is established on the second layer. The multi-layer nanocomposite material exhibits enhanced physical properties and stress dissipation while retaining desirable ductility.

### BRIEF DESCRIPTION OF THE DRAWINGS

Objects, features and advantages of embodiments of the present disclosure may become apparent upon reference to the following detailed description and drawings, in which:

FIG. 1A is a semi-schematic diagram depicting fabrication of a multi-layered nanocomposite for use in embodiment(s) of the present disclosure;

FIG. 1B is a semi-schematic diagram depicting an apparatus suitable for use in fabricating a multi-layered composite according to the diagram shown in FIG. 1A;

FIG. 2 is a semi-schematic diagram of a multi-layer nanocomposite material according to an embodiment of the present disclosure;

FIG. 3 is a semi-schematic diagram of a multi-layer nanocomposite material according to an alternate embodiment of the present disclosure;

FIG. 4 is a graph depicting aspect ratio versus tensile modulus;

FIG. 5 is a TEM micrograph of a 20-layer nanocomposite material formed according to an embodiment of the present disclosure, displaying the boundary between MB and neat PP layers, the arrows generally point to the boundary between a MB and a neat PP layer;

FIG. 6 is a TEM micrograph of a 20-layer nanocomposite material formed according to an embodiment of the present disclosure, showing aligned, partially exfoliated organoclay (OC) platelets; and

FIG. 7 is a TEM micrograph of a 640-layer nanocomposite material formed according to an embodiment of the present disclosure, showing a side view of dispersed OC platelets.

### DETAILED DESCRIPTION

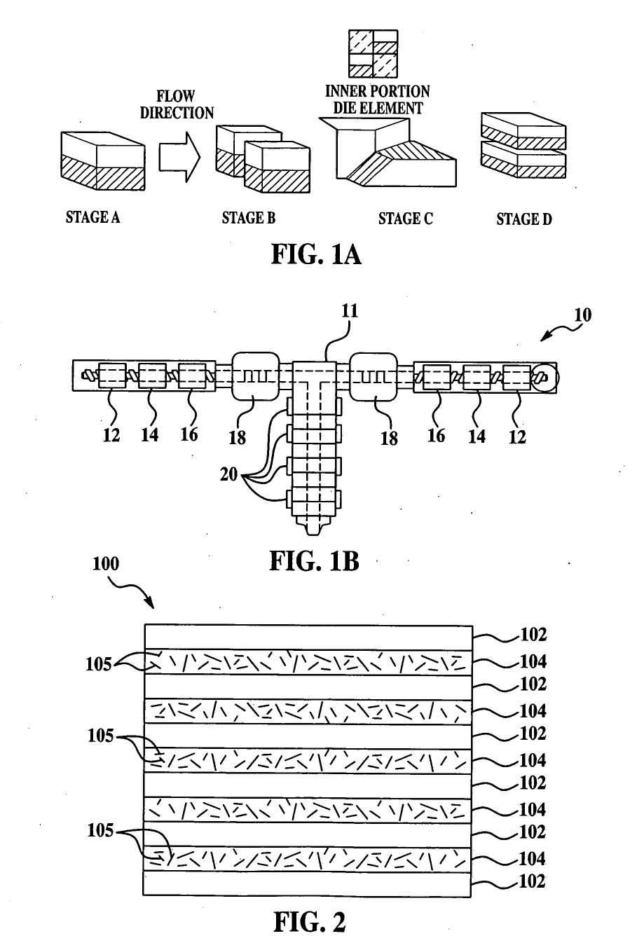

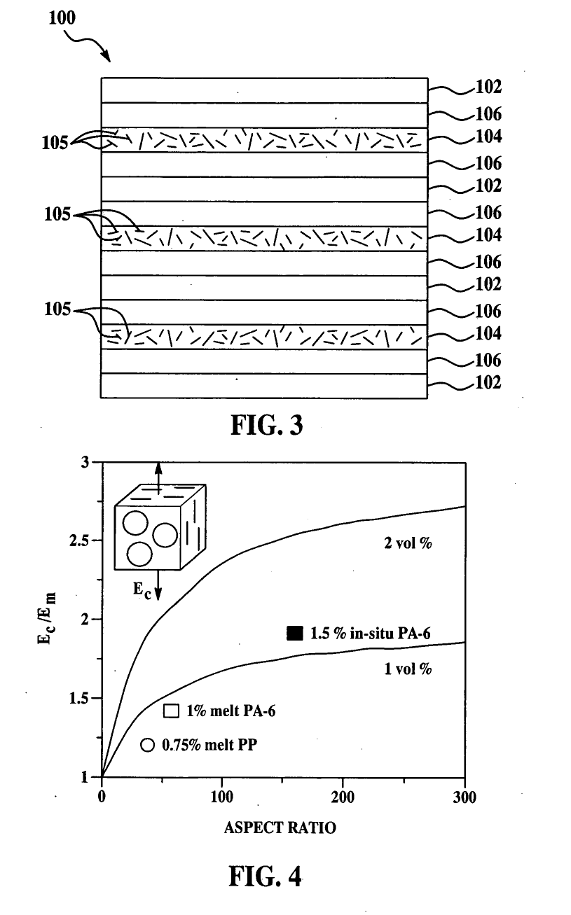

The present disclosure relates to co-extruded nanocomposite materials composed of alternating layers of two or more components with individual layer thicknesses ranging from the micro- to the nano-scale. The process of fabricating a multi-layered nanocomposite according to embodiment(s) of the present disclosure is shown in FIG. 1A. In the co-extrusion, at least two extruded streams of material converge in a single barrel (as depicted in STAGES A and B) in which multiplication dies continuously cut (as depicted in STAGE C) and stack the alternating two or more layers (as depicted in STAGE D). A third extruder (not shown) may be added to produce a third layer. The number of layers may range from the tens to the thousands. The thickness of the co-extruded nanocomposite material(s) generally depends on the thickness of the final film die and on the draw ratio during take-up, and may range from the micro- to the millimeter-scale. The thickness of the individual layers (e.g., 102, 104, 106 as described below) in the formed multi-layer nanocomposite material 100 (see FIGS. 2 and 3, described below) generally depends on the overall thickness of material 100 and the number of layers 102, 104, 106 present. For example, if the overall thickness of material 100 is 2 mm, and there are 6 layers present, each of the layers may be about 0.3 mm thick. However, it is to be understood that the layers forming material 100 may be roughly equal in thickness to each other, but generally are not exactly uniform in thickness to each other.

Depending on the composition of the layers, new types of materials having unique properties may be made with nanolayering process(es) as disclosed in embodiment(s) herein. The possibilities are numerous.

The apparatus 10 suitable for use in fabricating a nanocomposite according to embodiment(s) of the present disclosure is generally shown in FIG. 1B. Apparatus 10 is a pair of extruders feeding into a series of multiplication dies 20, including a co-extrusion block 11 having three heating zones 12, 14, and 16, and a metering pump 18 disposed on each side. A plurality of multiplication dies 20 are further operatively disposed on the co-extrusion block 11.

To attain high modulus and retain ductility, one in-coming feed stream may be pure polypropylene or any other suitable thermoplastic resin (one example of which is a polyamide that is compatible with the nano-filled layer and possesses a desired combination of physical properties), and the second feed stream (in an embodiment having two alternating layers) may be a nanocomposite polymer (e.g., polypropylene, impact copolymers, and/or elastomers, and/or the like, with nanofiller). The nanocomposite layer generally provides stiffness and strength, while the thermoplastic resin layer generally provides the impact resistance. A schematic diagram of an embodiment of a resulting nanocomposite is shown in FIG. 2.

Polypropylene (PP)/organoclay nanocomposites were prepared by both one- and two-step melt blending mechanisms. Two-step methods included compounding a master batch including about 10-25 wt % organoclay. Master batches were subsequently let down into neat PP, resulting in final blends with about 2-5 wt % organoclay. Transmission electron microscopy (TEM) was used to assess the extent of organoclay dispersion in the final samples. One optimum master batching method was developed. Without being bound to any theory, it is believed that employing multilayer coextrusion may advantageously create dispersed nanocomposites.

As discussed further herein, the present inventors have evaluated the effectiveness of such a master batch step on dispersing organoclay nanoparticles in PP matrices. Multilayer coextrusion is also evaluated as a method for preparing nanocomposite systems with well dispersed lamellae.

Embodiment(s) as disclosed herein offer many advantages, a few of which include the following. Lighter weight structural parts may be produced from multi-layer nanocomposite materials according to embodiment(s) disclosed herein to replace steel or aluminum. In addition, a stronger sheet stock may be used for less or equal cost than the conventional film that is presently used for vacuum-formed paint films.

It is believed, without being bound to any theory, that the multi-layering process(es) of the present embodiment(s) may advantageously enhance the physical and/or mechanical properties of the nanocomposite material, as well as the stress dissipation during impact of the multi-layered nanocomposite materials. It is further believed that the enhanced shear fields used in making the layered systems as disclosed in embodiment(s) herein may advantageously assist with the dispersion of the nanofiller materials within the nanocomposite material layer(s).

It is to be understood that embodiment(s) of the nanocomposite material(s) may be suitable for many applications. One non-limitative example of such an application includes use as an automotive interior body material and/or an automotive exterior body material.

Referring again to FIG. 2, in an embodiment, a multi-layer nanocomposite material 100 includes a first layer 102 of a first polymeric material and a second layer 104 of nanocomposite material. The nanocomposite material 104 includes a second polymeric material and a nanofiller material 105 exfoliated therewithin. The second layer 104 is established on the first layer 102, or the first layer 102 is established on the second layer 104. The thickness of each of the first and second layers 102, 104 may range from about 2 microns to about 400 microns.

A multi-layer structure 100, up to thousands of layers, may then be formed from alternating first 102 and second 104 layers. It is to be understood that any number of additional layers may be present, for example, a third layer 106 (see FIG. 3), fourth layer (not shown), etc. In those cases, the multi-layer structure 100 may be formed from alternating first 102, second 104, third 106 layers, or first 102, second 104, third 106, fourth layers, and/or the like.

In the non-limitative embodiment shown in FIG. 3, third layer 106 is interposed between layers 102 and 104. It is to be understood that layer 106 may be any suitable layer, as desired, including but not limited to a tie layer, another polymeric material layer, another nanocomposite material layer, and/or the like, and/or combinations thereof.

The thickness of the multi-layered nanocomposite material 100 may range from about 2 mm to about 4 mm. The multi-layer nanocomposite material 100 advantageously exhibits enhanced physical properties and stress dissipation while retaining desirable ductility.

In an embodiment, the facing surfaces (i.e. the surfaces in contact with an adjacent surface) of respective adjacent layers 102, 104; 102, 106, 104, 106 . . . ; etc. are generally substantially smooth, non-corrugated surfaces.

It is to be understood that the polymeric material of the first and second polymeric material may include any suitable thermoplastic materials. Further, the first and second polymeric materials may be the same or different. It may be desirable that the viscosities of the two or more materials introduced into the co-extruder have viscosities that are, and/or are made to be through manipulation of the extruder, similar.

If the first and second polymeric materials are different (i.e., the polymeric materials in the nanocomposite material 104 and the pure polymeric material in the first layer 102), it may or may not be desirable to include a tie layer therebetween, depending upon the materials chosen for the first and second polymeric materials. For example, a thermoplastic olefin (TPO) nanocomposite material alternating with ethylene propylene rubber (EPR) may generally not need a tie layer; whereas, a polyamide-6 nanocomposite layer alternating with a TPO may generally benefit from a tie layer therebetween.

In an embodiment, the thermoplastic materials include, but are not limited to, at least one of polypropylenes, polyethylenes, elastomers, impact copolymers thereof, polystyrene, polyethyleneterephthalate, polyamides, polymethylmethacrylate, polycarbonate, polyurethane, poly(acrylonitrile-co-butadiene-co-styrene) (ABS), poly(acrylonitrile-co-styrene-co-acrylate) (ASA), poly(styrene-co-butadiene-co-styrene) (SBS), polycarbonate-poly(acrylonitrile-co-butadiene-co-styrene) (PC-ABS), and mixtures thereof.

In an alternate embodiment, the polymeric material is a thermoplastic olefinic (TPO) material. The TPO may be at least one of polypropylene homopolymers, impact modified polypropylene, ethylene propylene elastomers, and mixtures thereof.

Some non-limitative examples of suitable polymeric materials are shown below in Table 1 under the labels “Polypropylenes,” “Propylene Copolymers” and “Elastomers.”

TABLE I

| MATERIAL | SUPPLIER | GRADE |
|---|---|---|
| Polypropylenes | Basell USA, Inc.; | Profax 6301, Profax |
| | Lansing, Michigan | 6323, Profax 6523, |
| | | Profax PD 702, Profax |
| | | PH020, Profax PH 382M |
| | Dow Chemical; | TF-1802 |
| | Midland, Michigan | |
| | Equistar Chemicals | Petrothene PP 8001-LK, |
| | LP; Houston, Texas | Petrothene PP 8020-AU, |
| | | Petrothene PP8020-GU |
| | ExxonMobil | PP-1074KN, PP1105E1, |
| | Chemical; Houston, | PP-3546G, PP1044 |
| | Texas | |
| | Huntsman Polymers | H0500NS, P4CCN-41 |
| | LLC; Marysville, | |
| | Michigan | |
| Propylene Copolymers | Basell USA, Inc.; | Profax 7101S, Metocene |
| | Lansing, Michigan | RM 1099, Profax |
| | | EL245S, Profax SD- |
| | | 242, Profax SG-702, |
| | | Profax SV-152, Hifax |
| | | CA53G |
| | Dow Chemical; | C700-35N, C702-20, 705- |
| | Midland, Michigan | 44 NA |
| | Equistar Chemicals | Petrothene PP36KK01, |
| | LP; Houston, Texas | Petrothene PP35FR03, |
| | | Petrothene PP35FU01, |
| | | Petrothene PP44FY01, |
| | | Petrothene PP44FZ01, |
| | | Petrothene PP8752HF, |
| | | Petrothene PP8462HR, |
| | | Petrothene PP8775HU |
| | ExxonMobil | PP-AX03BE5, |
| | Chemical; Houston, | PP822XE1, Mytex |
| | Texas | AN17K-01, PP7032KN, |
| | | PP7033N, PP8023 |
| Elastomers | Basell USA, Inc.; | Adflex KS021P, Adflex |
| | Lansing, Michigan | KS357P, Hifax CA207A, |
| | | Hifax CA10GC, Hifax |
| | | CA244 |
| | Dupont-Dow | Engage 8100, Engage |
| | Elastomers LLC; | 8150, Engage 8200, |
| | Wilmington, | Engage 8440, Engage |
| | Delaware | 8540, Engage 8842, |
| | | Nordel IP NDR3722P, |
| | | Nordel IP NDR4820P, |
| | | Nordel IP NDR3670, |
| | | Nordel IP NDR4725P, |
| | | Nordel IP NDR4770R |
| | Equistar Chemicals | Petrothene PP8312-KO, |
| | LP; Houston, Texas | Petrothene PP43QW02 |
| | ExxonMobil | Exact 0201, Exact 0210, |
| | Chemical; Houston, | Exact 8201, Exact 8210, |
| | Texas | Exact 4053, Exact 4041, |
| | | Exact 3035, Vistalon 404, |
| | | Vistalon 707, Vistalon |
| | | 785 |

It is to be understood that the nanofiller material 105 may be any suitable nanofiller material. In an embodiment, the nanofiller 105 is a clay material. Examples of suitable clay materials include, but are not limited to at least one of smectite, hectorite, montmorillonite, bentonite, beidelite, saponite, stevensite, sauconite, nontronite, illite, and mixtures thereof. It is to be understood that the clay material may be an organically modified clay material, e.g. an organoclay. In an embodiment, the nanofiller material is an aluminum silicate smectite clay. In a further embodiment, the nanofiller is organically modified montmorillonite and/or organically modified hectorite.

Some non-limiting examples of suitable nanofiller material 105 are selected from Cloisite 20A, Cloisite 93A, Cloisite 15A, Cloisite 10A, Bentone 108, Bentone 109, Nanomer I.30P, Nanomer I.31PS, Nanomer I.44P, Nanomer I.44PS, and combinations thereof. The Cloisite and Nanomer nanofiller materials are organically modified montmorillonite clays. The Bentone nanofiller materials are organically modified hectorite clays. Cloisite clays are commercially available from Southern Clay Products, Inc., in Gonzales, Tex. The Nanomer clays are commercially available from Nanocor, Inc. in Arlington Heights, Ill. The Bentone clays are commercially available from Elementis Specialties in Hightstown, N.J.

To further illustrate embodiment(s) of the present disclosure, the following example is given. It is to be understood that this example is provided for illustrative purposes and is not to be construed as limiting the scope of embodiment(s) of the present disclosure.

### Example

Materials. The resin used in this study was an injection molding grade polypropylene (PP), Pro-fax PH020 (Basell Polyolefins). It has a melt flow rate of 37 g/10 min at 230° C./2.16 kg. A maleic anhydride grafted polypropylene, Fusabond P MD353D (DuPont) (PP-g-MA) was used as a compatibilizer. It has 1.4 wt % MA grafting and a melt flow of 450 g/10 min at 190° C./2.16 kg.

The organoclay (OC) used in this study was Cloisite 20A. It is natural montmorillonite clay modified with 95 meq of quaternary ammonium salt (dimethyl-dihydrogenated tallow-quaternary ammonium chloride)/100 g clay. Following chemical treatment, the clay has an initial interlamellar Dooi spacing of 24 Å and is 62 wt % inorganic.

Nanocomposite Preparation. Prior to melt-blending each sample, the ingredients were premixed in sealed containers to ensure substantial sample homogeneity.

Master batches (MB) may be prepared using any conventional melt-blending equipment. Common examples of such equipment include twin screw extruders and internal batch mixers.

Multilayer extrusion uses two ¾″ single screw extruders (Davis-Standard, Wayne) to feed a central 20-layer feed block. One extruder fed master batch material while the other fed neat PP. The molten polymers then passed through a series of multiplication (doubling the total number of layers each time) and calming (helping to establish pressure uniformity in the multiplication dies) dies. The melt then passed through a coat hanger section before exiting a final slit die. The extrudate passed through water-cooled chill rolls before being collected. The extruders and dies for this operation were at 175° C. Samples were prepared with either 20 or 640 layers.

Characterization. Thin sections (˜80 nm) from the tensile bars were prepared for TEM imaging by cryo-microtomy using a Reichert Jung ultra-microtome at −60° C. using a diamond knife. TEM micrographs for this study were obtained using a Philips 430t microscope with an accelerating voltage of 300 kV.

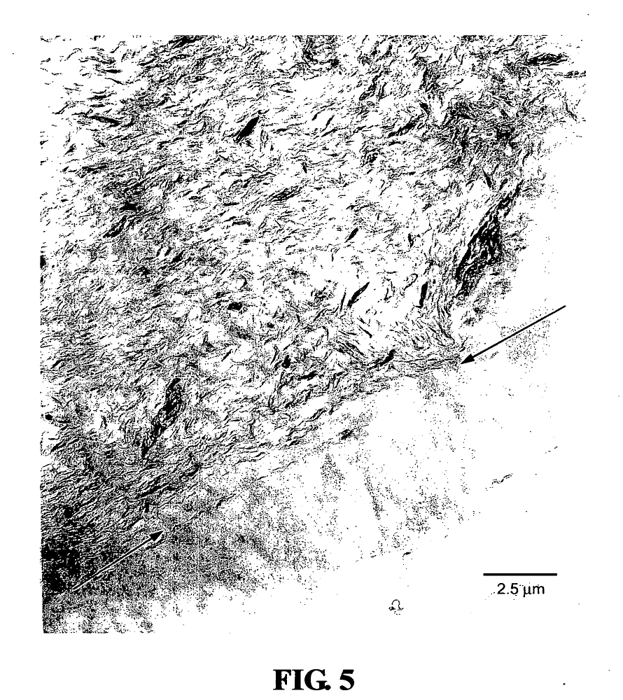

Multilayer. The process for creating nanocomposite samples was multilayer coextrusion. Multilayer coextrusion is not a mixer; it is traditionally used to generate interfaces or to create optical properties in a material. Samples containing 20 and 640 alternating layers of MB and neat PP were extruded. As FIG. 5 shows for 20-layer, 5% clay (2C20-5), every alternate layer contains no OC, and a full-sample percolation was not possible.

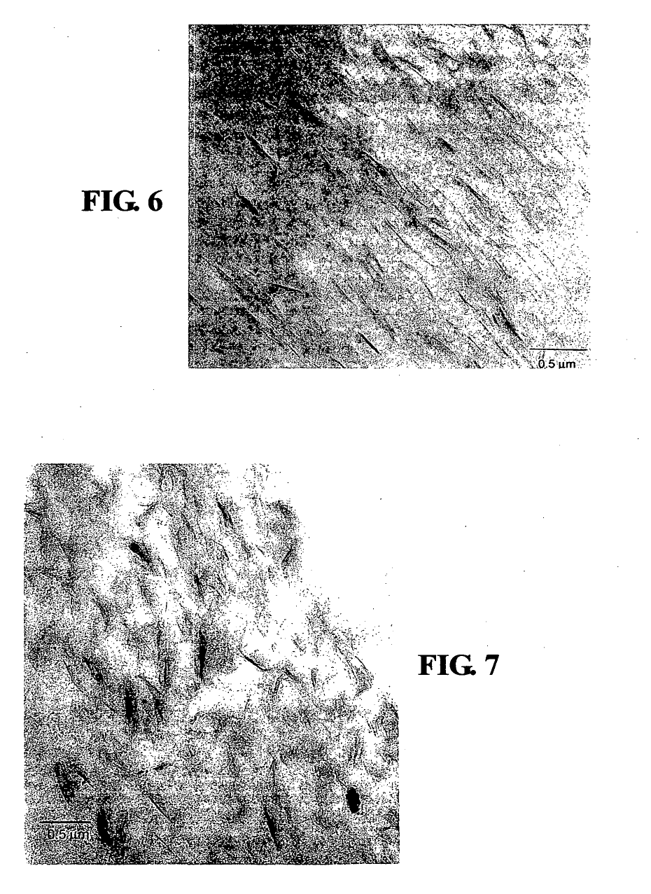

Multilayer nanocomposites proved to be excellent samples for TEM. FIG. 6 shows that the 2C20-2 was partially exfoliated in the OC containing layers. However, an important benefit of multilayer extrusion is the alignment of the OC platelets in the extrudate. TEM micrographs of general extrudate (such as from a twin screw) generally have some alignment, but images tend to show platelets in many orientations. When platelets are randomly oriented in all three planes, 2D imaging presents challenges in accurately quantifying measurements from the micrographs, such as when calculating an aspect ratio. By substantially fully aligning the particles and carefully microtoming the samples, it is possible to get high quality side view images of platelet stacks (FIG. 6). This is also displayed in FIG. 7 for the 2C640-3 sample which has very good dispersion. Additionally, multilayer coextrusion is a valuable tool for preparing samples with aligned platelets for barrier applications.

Conclusions. Multilayer coextrusion has been evaluated as a method for dispersing organoclay in PP. The multilayer line was able to align and partially disperse organoclay throughout regions initially containing organoclay; not being a mixer, multilayer extruded samples exhibited clear layer boundaries between master batch and neat PP layers. Careful microtoming and high resolution of multilayer images allows for the calculation of overall aspect ratio. It is contemplated as being within the purview of the present disclosure to blend MB and neat PP in each layer in order to assess possible improvement in the barrier properties of the coextruded samples.

TABLE 1
Blend Compositions and Process History

| | Weight fractions | | | |
|---|---|---|---|---|
| | | Maleic | | |
| | | Anhydride- | | |
| | Polypropylene | grafted | | |
| Sample | Resin | Polypropylene | Organoclay | Processing |
| 2C20-2 | 93 | 5 | 2 | multilayer |
| 2C20-3 | 92 | 5 | 3 | multilayer |
| 2C20-5 | 90 | 5 | 5 | multilayer |
| 2C640-2 | 93 | 5 | 2 | multilayer |
| 2C640-3 | 92 | 5 | 3 | multilayer |
| 2C640-5 | 90 | 5 | 5 | multilayer |

While several embodiments of the disclosure have been described in detail, it will be apparent to those skilled in the art that the disclosed embodiments may be modified. Therefore, the foregoing description is to be considered exemplary rather than limiting.

1. A multi-layer nanocomposite material, comprising:
a first layer of a first polymeric material; and
a second layer of nanocomposite material including a second polymeric material and a nanofiller material exfoliated therewithin, the second layer being in contact with the first layer;
wherein the multi-layer nanocomposite material exhibits enhanced physical properties and stress dissipation while retaining ductility.

2. The material as defined in claim 1 wherein each of the first and second polymeric materials comprises at least one, independently selected thermoplastic material.

3. The material as defined in claim 2 wherein the thermoplastic material is selected from polypropylenes, polyethylenes, elastomers, impact copolymers thereof, polystyrene, polyethyleneterephthalate, polyamides, polymethylmethacrylate, polycarbonate, polyurethane, poly(acrylonitrile-co-butadiene-co-styrene) (ABS), poly(acrylonitrile-co-styrene-co-acrylate) (ASA), poly(styrene-co-butadiene-co-styrene) (SBS), polycarbonate-poly(acrylonitrile-co-butadiene-co-styrene) (PC-ABS), and mixtures thereof.

4. The material as defined in claim 2 wherein the thermoplastic materials comprise one of thermoplastic olefins including at least one of polypropylene homopolymers, impact modified polypropylene, ethylene propylene elastomers, and mixtures thereof.

5. The material as defined in claim 1 wherein the nanofiller material comprises a clay material selected from smectite, hectorite, montmorillonite, bentonite, beidelite, saponite, stevensite, sauconite, nontronite, illite, and mixtures thereof.

6. The material as defined in claim 1, further comprising a plurality of alternating first and second layers.

7. The material as defined in claim 1 wherein a thickness of each of the first and second layers ranges from about 2 microns to about 400 microns.

8. The material as defined in claim 1 wherein an overall thickness of the multi-layer nanocomposite material ranges from about 2 mm to about 4 mm.

9. The material as defined in claim 1, further comprising a third layer established between the first layer and the second layer.

10. The material as defined in claim 1, wherein the first polymeric material and the second polymeric material are the same material.

11. The material as defined in claim 1, further comprising at least a third layer in contact with at least the first layer or the second layer.

12. A method for forming a multi-layer nanocomposite material, the method comprising:
co-extruding a first layer of a first polymeric material with a second layer of nanocomposite material including a second polymeric material and a nanofiller material exfoliated therewithin, thereby forming the multi-layer nanocomposite material;
wherein the multi-layer nanocomposite material exhibits enhanced physical properties and stress dissipation while retaining ductility.

13. The method as defined in claim 12, further comprising passing the multi-layer nanocomposite material through at least one multiplication die to form a four layer multi-layer nanocomposite material having alternating first and second layers.

14. The method as defined in claim 13, further comprising passing the multi-layer nanocomposite material through the at least one multiplication die a sufficient number of times to form a 20 layer or a 640 layer multi-layer nanocomposite material having alternating first and second layers.

15. The method as defined in claim 12, further comprising:
co-extruding a third layer of a third polymeric material with the first layer and the second layer to form the multi-layer nanocomposite material; and
passing the multi-layer nanocomposite material through at least one multiplication die to form a multi-layer nanocomposite material having alternating first, second and third layers, wherein each of the third layers is established between respective first and second layers.

16. The method as defined in claim 15, further comprising at least one additional layer in the multi-layer nanocomposite material.

17. A nanocomposite material formed by the method of claim 12.
